(19) United States
(12) Patent Application Publication
(10) Pub. No.: US 2002/0098130 A1
(43) Pub. Date: Jul. 25, 2002

(54) Apparatus for purifying and deodorizing air

(75) Inventor: William Wing Hai Fong, Kin (HK)

Correspondence Address: RICHARD K. WARTHER, ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: Lentek International, Inc., Orlando, FL (US)

(21) Appl. No.: 09/919,488

(22) Filed: Jul. 31, 2001

Related U.S. Application Data
(60) Provisional application No. 60/223,382, filed on Aug. 7, 2000.

(51) Int. Cl. B01J 19/08

(52) U.S. Cl. 422/186.04

(57) ABSTRACT

An apparatus for purifying and deodorizing air includes a housing and electrode positioned within the housing and having a plurality of emitter members extending from the electrode. A collector plate is mounted within the housing and has a plurality of holes such that a hole is positioned adjacent a respective emitter member. A high voltage generating source is positioned within the housing for applying a high voltage between the electrode and collector plate. The emitter members are moveable relative to the holes within the collector plate for selecting between: (a) an oxidating mode of operation that enhances ozone production to allow an oxygen to split off therefrom for oxidizing and neutralizing pollutants, and (b) an ionic release mode of operation for enhancing the generation of positive and negative ions such that negative ions attach to pollutants that drop out of the air.

### RELATED APPLICATION

This application is based upon prior filed copending provisional application Serial No. 60/223,382 filed Aug. 7, 2000.

### FIELD OF THE INVENTION

This invention relates to air purifiers, and more particularly, this invention relates to an apparatus for purifying and deodorizing air that uses an electrode for generating ozone and positive and negative ions.

### BACKGROUND OF THE INVENTION

The increase of outdoor air pollution over many years has created a greater awareness to people for the type of damage that outdoor air pollution can cause to one's health. What is not commonly known, however, is that indoor air pollution also exists, and can have a significant effect on one's health. There have been recent Environmental Protection Agency studies that indicate certain levels of air pollution indoors could be 2-5 times higher than the ambient outdoor air pollution level. It is estimated by some that on rare occasions, these indoor air pollution levels can be 100 times higher than outdoor air pollution levels. This is an increasingly important matter that must be addressed because some people spend 90% of their time indoors, especially infants and the elderly. Some of these indoor pollutants could also be contributing factors to frequent and unexplained headaches or sleepless nights that afflict numerous persons within the general population.

There have been numerous prior art apparatus designed and manufactured for purifying air. Some of these apparatus generate ions using complicated wire grid arrays or generate ions with high voltage electrode arrays. Some use fans for moving air, and similar complicated apparatus. Some of these prior art devices are mounted in large housings containing fans and other complicated moving parts and filters. Often, the devices become clogged with pollutants, requiring disassembly of fan assemblies, replacement and/or repair of high generating voltage sources, extensive clearing of arrays of wires and electrodes that help create air movement, and replacement of filters that clog the apparatus unless cleaned. These devices are certainly more complicated and perhaps more expensive than what some users may anticipate or desire.

### SUMMARY OF THE INVENTION

It is therefore an object of the present invention to provide an apparatus for purifying and deodorizing air that overcomes the drawbacks of prior art air purifiers as noted above.

The present invention is advantageous and provides an apparatus for purifying and deodorizing air that allows configuration between: (a) an oxidating mode of operation that enhances ozone production to allow an oxygen to split off therefrom for oxidizing and neutralizing pollutants, and (b) an ionic release mode of operation for enhancing the generation of positive and negative ions such that negative ions attach to pollutants that drop out of the air. The apparatus includes a housing that is efficient in design. A collector plate (e.g., colector grid) is removable within the housing to facilitate cleaning. Thus, no filters are required. The apparatus is preferably operable off a standard 110 volt household outlet.

In one aspect of the present invention, the apparatus includes a housing and an electrode positioned within the housing. The electrode has a plurality of linear arranged emitter members extending from the electrode. A collector plate is mounted within the housing and has a plurality of holes such that when mounted within the housing a hole is positioned adjacent a respective emitter member. The collector plate is slidably mounted within the housing such that it can be removed readily from the housing for cleaning. A voltage generating source is mounted within the housing and applies a high voltage between the electrode and collector plate. This voltage generating source preferably generates a high voltage output of up to about 7,500 volts DC. The emitter members include emitter points and are moveable relative to the holes within the collector plate for selecting between: (a) an oxidating mode of operation that enhances ozone production to allow an oxygen to split off therefrom for oxidizing and neutralizing pollutants, and (b) an ionic release mode of operation for enhancing the generation of positive and negative ions such that negative ions attach to pollutants that drop out of the air.

In yet another aspect of the present invention, the electrode is pivotally mounted within the housing for moving the emitter members relative to the holes within the collector plate. When the emitter members extend adjacent respective holes in the oxidating mode of operation and extend prone relative to the holes in the ionic release mode of operation. In yet another aspect of the present invention, the emitter members comprise triangular configured members terminating in an emitter point that is positioned substantially central to a respective hole when in an oxidating mode of operation. These triangular configured members extend from the electrode. The electrode can be longitudinally extending and mounted on a longitudinally extending electrode support member that is rotatable a predetermined arc distance within the housing to allow pivoting movement of the emitter members.

In still another aspect of the present invention, the voltage generating source is operative from power based on a standard household current. In another aspect of the present invention, the high voltage source is operative for generating a sawtooth waveform and comprises a transformer, transistor and diode circuit in one non-limiting aspect. A user operable switch is carried by the housing and operable for manually switching between the oxidating and ionic release modes of operation.

### BRIEF DESCRIPTION OF THE DRAWINGS

Other objects, features and advantages of the present invention will become apparent from the detailed description of the invention which follows, when considered in light of the accompanying drawings in which:

FIG. 1 is an enlarged, front isometric view of the apparatus for purifying and deodorizing air in accordance with the present invention and showing the front housing member with air slots therein.

FIG. 2 is another isometric view of the apparatus of the present invention looking in the direction along line 2 of FIG. 1, and showing the user operable switch carried by the housing and operable for manually switching between the oxidating and ionic release modes of operation, and showing the collector plate slidably mounted within the housing, and the two electrical prongs for plugging the apparatus into a standard receptacle for running off of household current.

FIG. 3 is another front isometric view showing the front housing member and the collector plate partially slid out from the housing.

FIG. 4 is a rear plan view of the interior of the front housing member showing the collector plate retainer and the collector plate slid within the front housing member.

FIG. 5A is a plan view of the collector plate retainer removed from the front housing member.

FIG. 5B is a plan view of the front housing member showing the collector plate partially removed from the front housing member.

FIG. 6 is another plan view of the front housing member showing the collector plate inserted completely within the front housing member.

FIG. 7 is a plan view of the collector plate.

FIG. 8 is a plan view of the rear housing member showing the high voltage generating source mounted therein, and the electrode pivotally mounted within the rear housing member such that the emitter points extend vertically toward a respective hole in the collector plate in an oxidating mode of operation.

FIG. 9 is another plan view of the rear housing member similar to FIG. 8, but showing the emitter points extending prone for an ionic release mode of operation.

FIG. 10 is another plan view of the front housing member and showing the high voltage generating source and its voltage source retainer plate removed from the housing.

FIG. 11 is a schematic circuit diagram of the high voltage generating source that can be used with the present invention.

FIG. 12 is an illustrative output waveform such as generated from a circuit similar to that shown in FIG. 11, which is operative with the apparatus of the present invention.

FIG. 13 is a fragmentary view illustrating the apparatus operation in the oxidating mode of operation.

FIG. 14 is another fragmentary view illustrating the oxidating mode of operation.

FIG. 15 is a fragmentary view illustrating the apparatus operation in the ionic release mode of operation.

FIG. 16 is another output waveform that is operable with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The apparatus of the present invention is advantageous for purifying and deodorizing air because it allows selection between: (a) an oxidating mode of operation that enhances ozone production to allow an oxygen to split off therefrom for oxidizing and neutralizing pollutants, and (b) an ionic release mode of operation for enhancing the generation of positive and negative ions such that negative ions attach to pollutants that drop out of the air. The present invention is also advantageous because it provides a sturdy and attractively designed housing with internal compartments that operate silently. It has no moving parts except a pivoting electrode that is manually actuable. The apparatus can plug directly into any 110 volt household outlet and, in one aspect of the present invention, could run on two-watts of power. It has no filter to change or batteries to replace and does not require a fan or other means for moving air. The collector plate is formed preferably from stainless steel and acts as a collector grid that can be removed from the housing and wiped with a clean cloth. The apparatus preferably includes a power indicator, light emitting diode (LED) to indicate that power is on. A night light is preferably included.

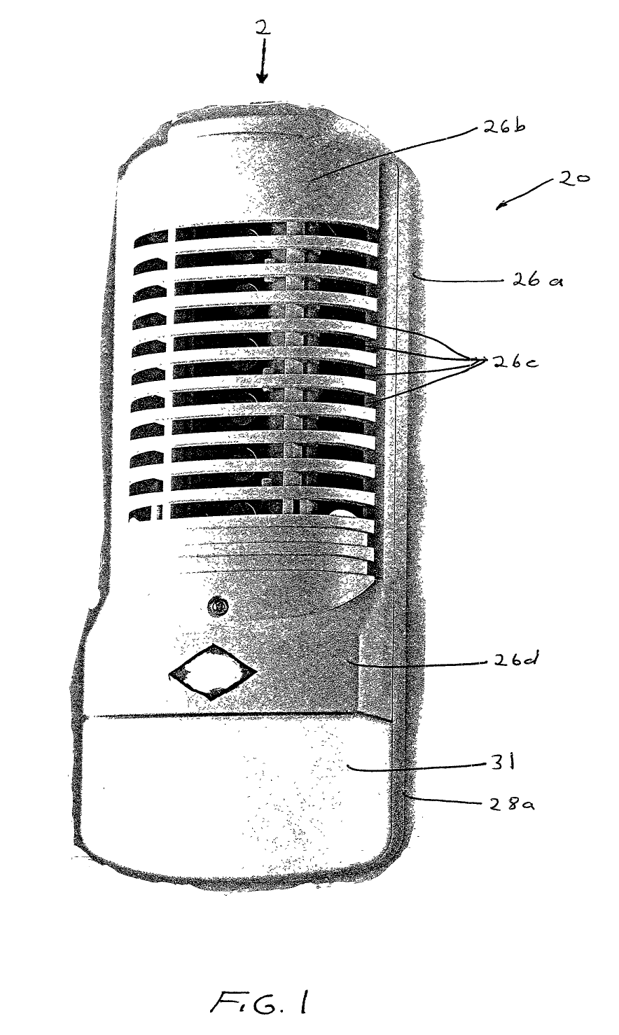

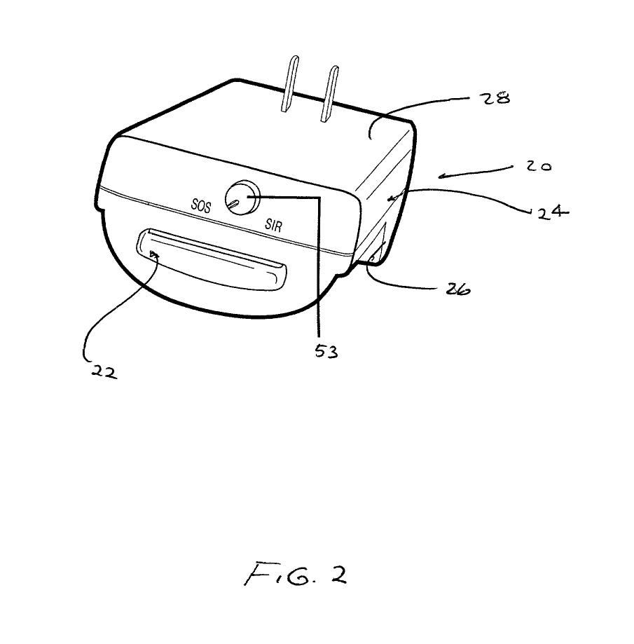

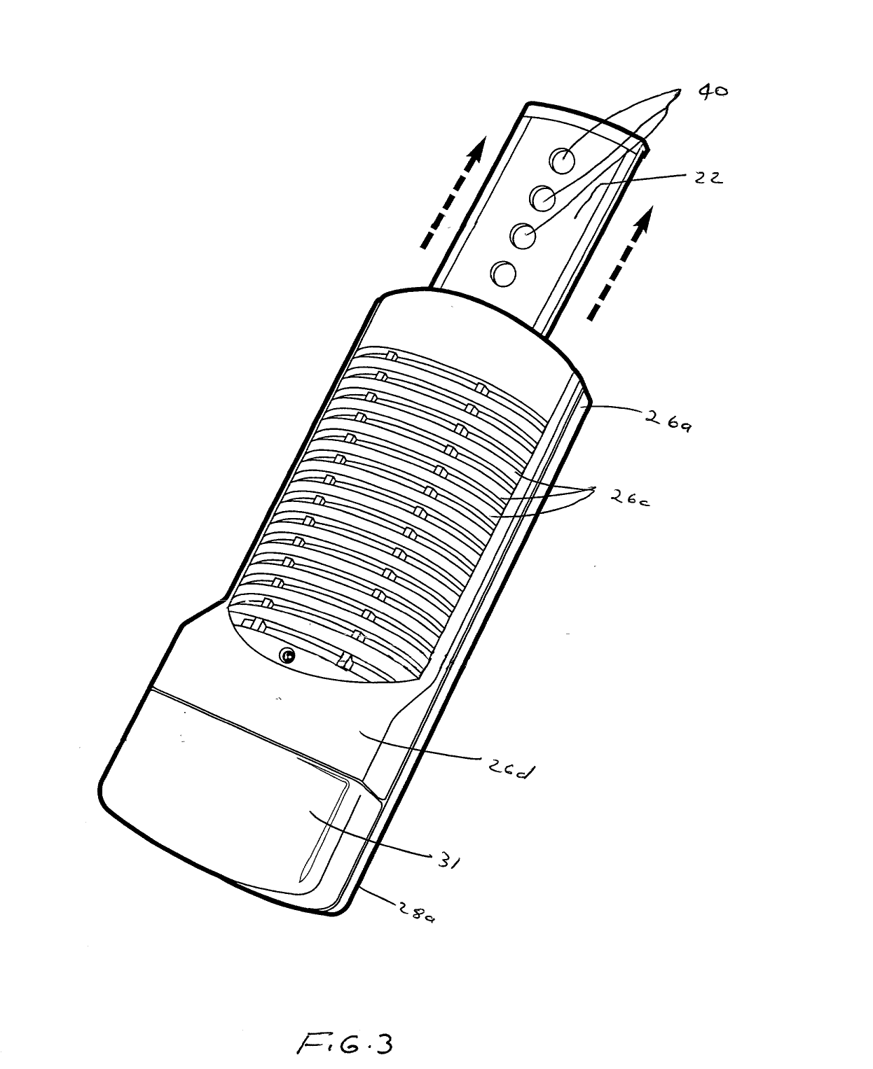

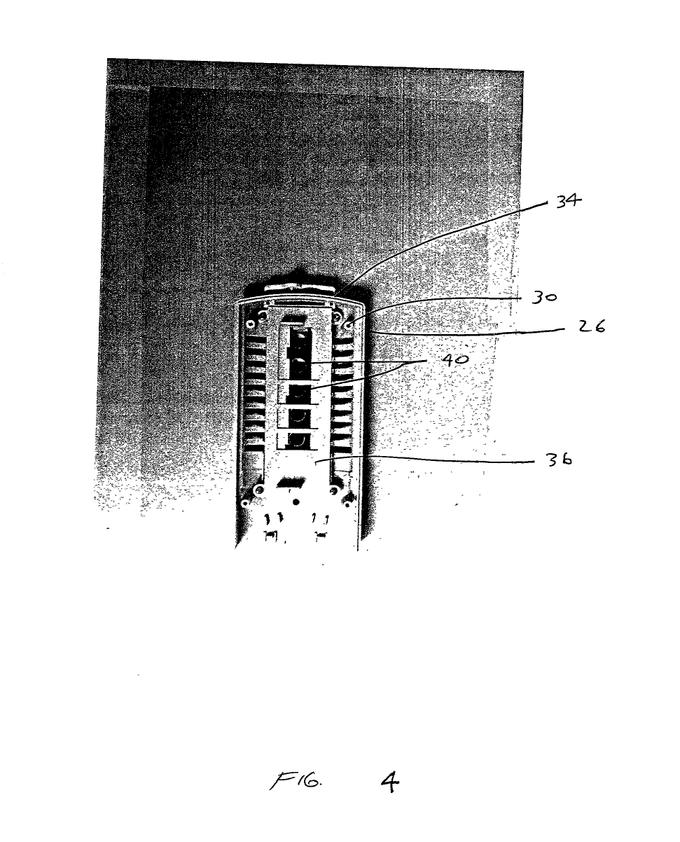

FIGS. 1-3 show perspective views of the apparatus 20 of the present invention, i.e., a front isometric (FIG. 1), a top isometric (FIG. 2), and another front isometric view (FIG. 3), showing in FIG. 3 the collector plate 22 slid partially out of the housing 24 for easy cleaning. As shown in FIGS. 4 and 8, the housing includes a front housing member 26 and a rear housing member 28 that fit together and are retained together by retaining members 30, such as screw fasteners or clips. The upper portion 26a of the front housing member 26 includes an outwardly curved or concave surface 26b that includes air slots 26c to permit air entry and egress within the housing (FIG. 1). The lower portion 26d of the front housing member 26 includes a clear or translucent night light cover 31 that extends over and is retained on the lower portion 28a of the rear housing member 28.

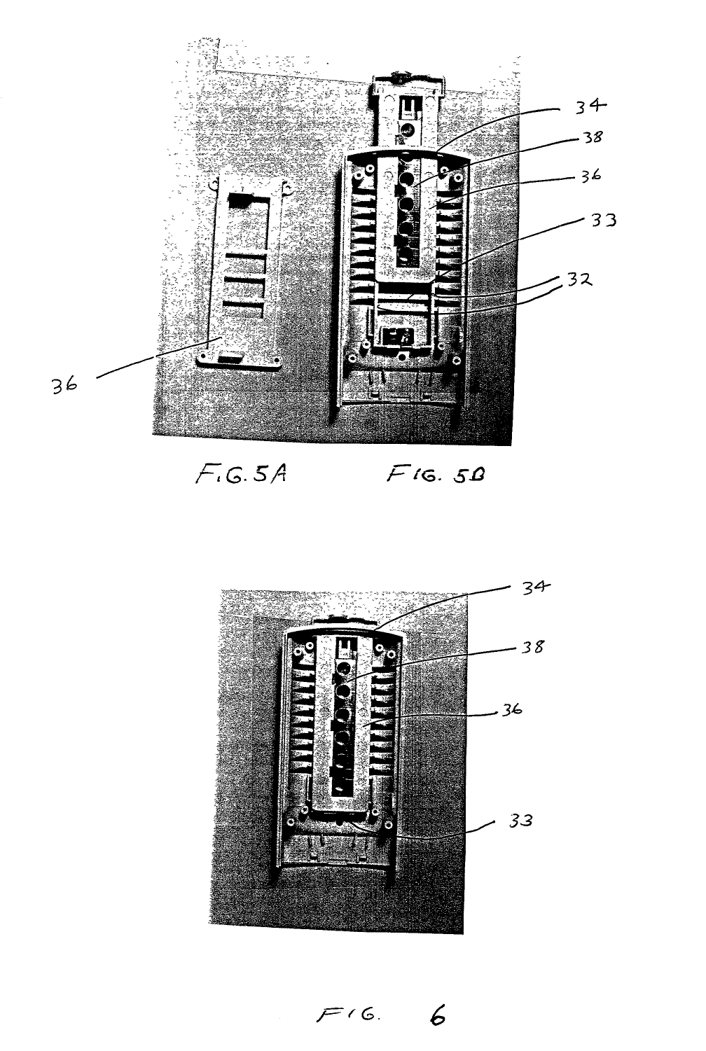

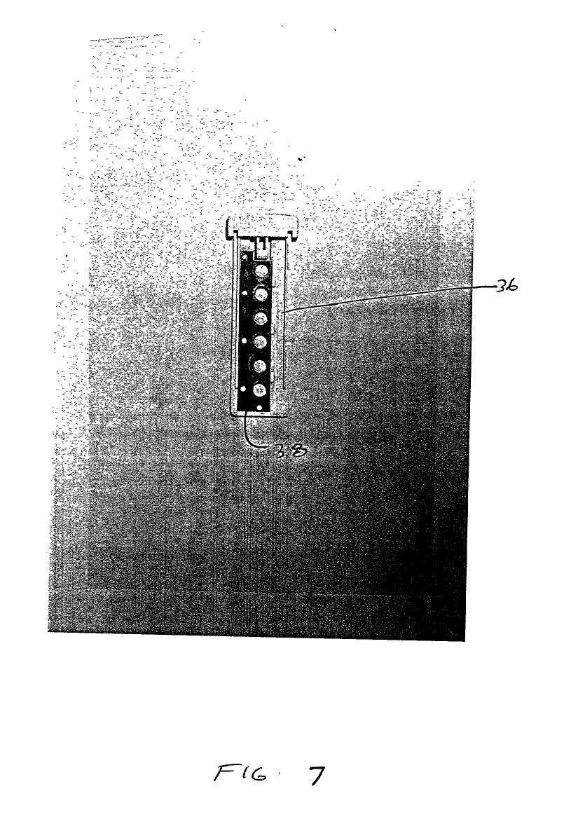

As shown in FIG. 5B, the interior section front housing member 26 includes two guide channels 32 forming a collector plate receiving channel 33 for receiving the collector plate 22, which is slidably mounted within the top portion of the front housing member through a collector plate receiving slot 34 (FIGS. 4, 5A, 5B and 6). A collector plate retainer 36 (FIGS. 4 and 5A) extends over the collector plate receiving channel 33 to maintain the collector plate in its proper position and prevent the collector plate from “wobbling” or pivoting within the housing. This allows only linear movement of the collector plate into and out from the housing through the collector plate receiving slot.

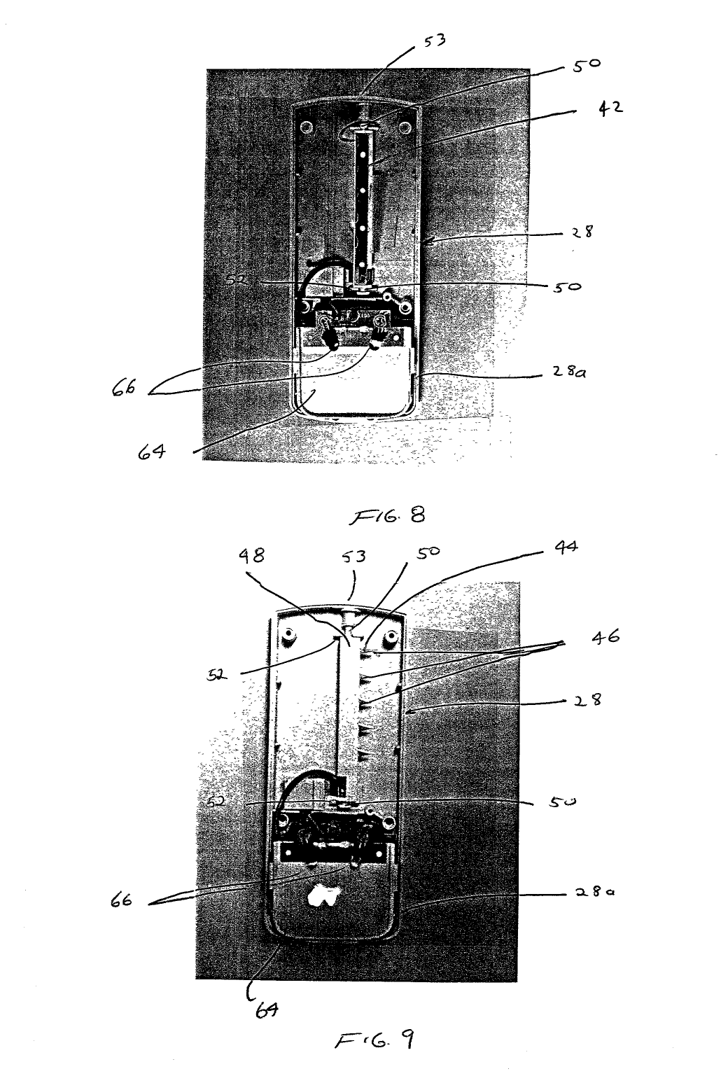

As illustrated in FIG. 7, the collector plate is formed to include a preferably plastic carrier member 36, such as formed from injection molding or similar techniques, and carries a metallic collector plate member 38 on the carrier member 36. The carrier member 36 is described as formed from plastic. Other materials could be used as suggested by those skilled in the art. The collector plate member could be formed from stainless steel or similar materials. The carrier member and collector plate member could be formed as one structure. The collector plate 22 includes a plurality of holes 40 formed in collector plate member 38 that are preferably linearly aligned and are of substantially the same size, as illustrated.

As shown in FIG. 8, an electrode 42 is mounted within the rear housing member 28 and has a plurality of linear positioned emitter members 44 that extend from the electrode and formed as triangular configured emitter members having terminating emitter points 46. The electrode 42 is longitudinally extending and mounted on a longitudinally extending electrode support 48 that is rotatably mounted within the rear housing member 28. Although the electrode emitter members and holes are arranged serially, they could be arranged in an array or other geometric configuration.

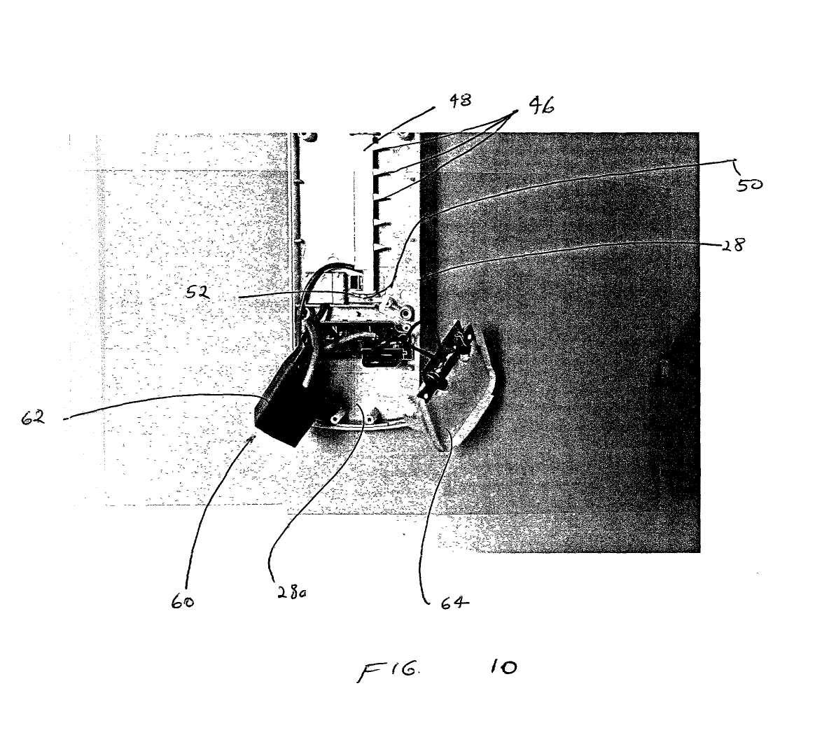

As illustrated in FIGS. 8 and 9, the electrode support 48 with the mounted electrode 42 extends longitudinally along an axis defined by the housing 24. The electrode support 48 includes mounting shafts 50 at either end, which are received in shaft mounts 52 having circular cut-outs that receive the shaft 50 to allow pivotal rotation of the electrode support 48.

As the electrode support 48 is pivotally moved, the emitter members 44 are pivoted into a raised, vertical position where the emitter points are in a central portion of a respective hole of the collector plate. When pivoted in the other manner, the collector points and emitter members 44 lie substantially prone relative to the holes in the collector plate.

It is evident that when the front housing member 26 and rear housing member 28 are secured together, the collector plate 22, when inserted within the housing 24, is positioned such that a hole is positioned adjacent a respective emitter member as described before. A user operable control knob or switch 53 is positioned at the end of the electrode support 48 in a portion extending through the top of the front housing member. The knob 52 is positioned outside the housing as shown in FIG. 2 and allows a user to select rotatable movement of the electrode, such that the emitter members are moveable relative to the holes within the collector plate for selecting between: (a) an oxidating mode of operation that enhances ozone production to allow an oxygen to split off therefrom for oxidizing and neutralizing pollutants, and (b) an ionic release mode of operation for enhancing the generation of positive and negative ions such that negative ions attach to pollutants that drop out of the air.

The electrode support is pivotally mounted such that any emitter members are positioned relative to the holes within the collector plate. The emitter points formed by the triangular configured emitter members extend substantially between and in the middle of respective holes in the oxidating mode of operation and extend prone relative to the holes when in the ionic release mode of operation. Typically, the emitter points are extended such that the emitter points lie substantially within or near a plane defined by the collector plate, with the emitter points forming the terminus of the triangular configured emitter members positioned at the center of the respective hole within the plane or substantially at the plane. In one aspect of the present invention, the holes and emitter members are substantially equidistantly spaced from respective adjacent holes or members and linearly arranged.

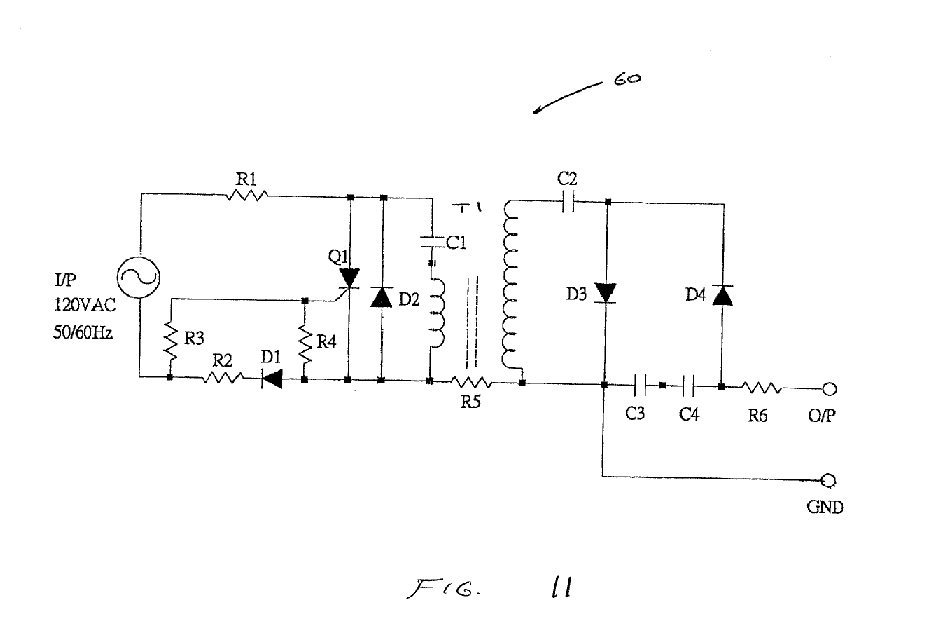

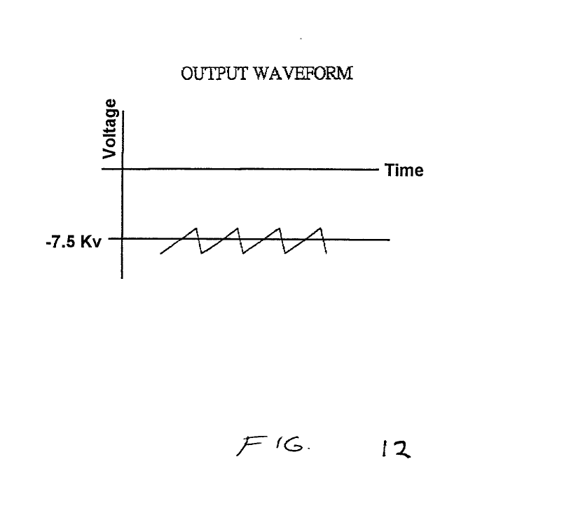

As shown in FIG. 10, and in the schematic circuit diagram of FIG. 11, a high voltage generating source 60 is mounted within the housing 24 for applying a high DC voltage between the electrode 42 and collector plate 22. The high voltage generating source is preferably positioned in a generator housing 62, as shown in FIG. 10, and retained in the rear housing member 28 by a voltage source retainer plate 64. A respective “power on” and night light emitting diode (LED) 66 is operatively connected to the night light generating source 60. The LED's 64 illustrate “power on” i.e., the unit is operating. The LED's 66 are positioned within a night light cover 31 that mounts over the rear housing member LED's 66 and preferably are positioned on retainer plate 64.

As shown in the schematic circuit diagram of FIG. 11, the apparatus 20 is operable with standard household current such that the apparatus can be plugged into a normal wall outlet for 120 volt AC current supply. It is possible, however, depending on the transformer and chosen circuit, to operate off of 220 volts or other voltage source. It is possible that the unit could be battery operated. A transistor Q1 is operable with diodes D1 and D2 and transformer T1 to increase the voltage and rectify same with rectifying diodes D3 and D4 such that a voltage output could have a sawtooth waveform (FIG. 12) and could be generated as high to about −7.5 kv, (i.e., 7,500 volts). Another waveform could be generated with a modified circuit, where the waveform is shown in FIG. 16. The transistor Q1 is operable with the various resistors R1, R2, R3, R4 and capacitor C1 that are coupled with the transformer. Transformer T1 includes transformer resistor R5 and operable as known to those skilled in the art. Output capacitors C2, C3 and C4 provide some current ripple control and are operable with load resistor R6.

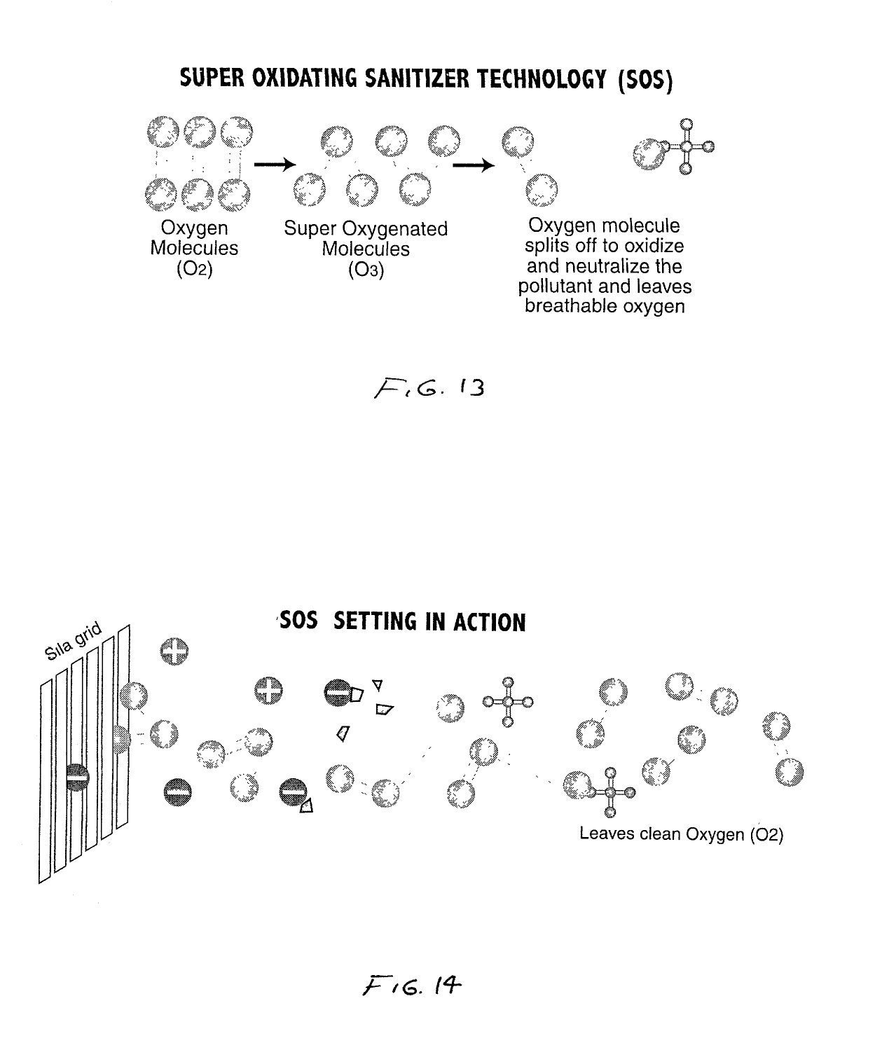

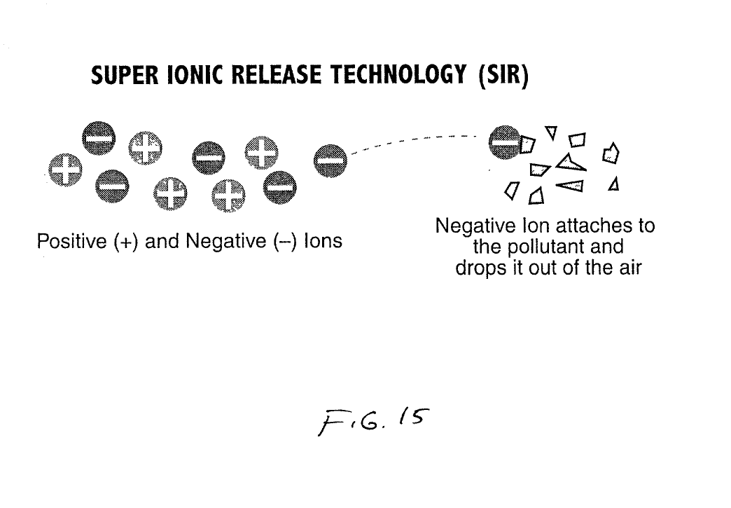

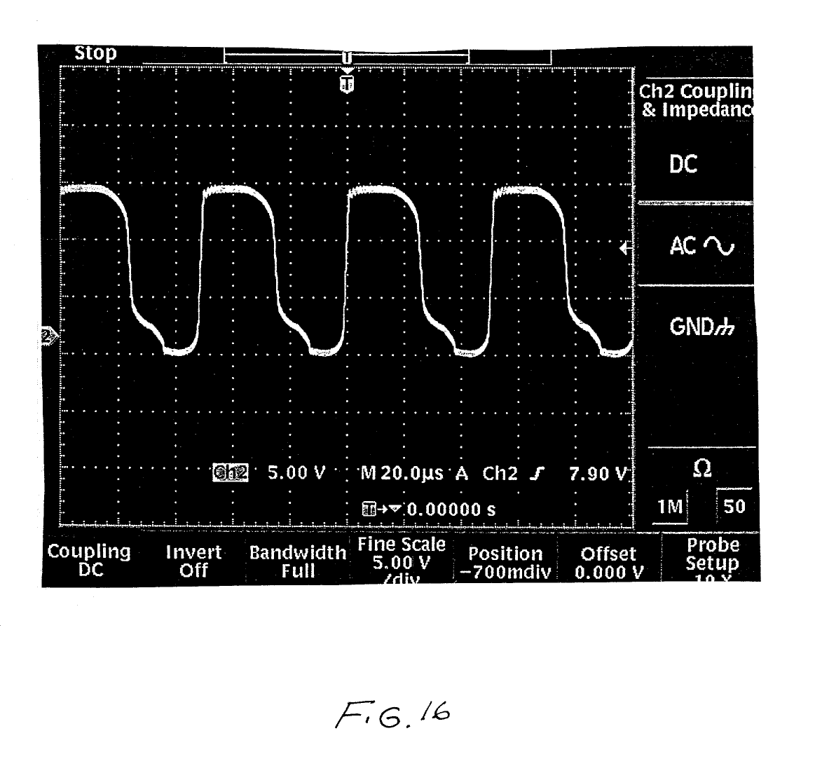

In operation, the apparatus is operable by selecting the configuration SOS (FIG. 2) for the oxidating mode of operation or SIR for the ionic release mode of operation. In the SOS, oxidating mode of operation as shown in FIGS. 13 and 14, oxygen molecules O₂ become superoxygenated molecules (O₃) (i.e., ozone), wherein an oxygen molecule splits off to oxidize and neutralize pollutants and leave breathable oxygen. When the manually operable switch is selected to SIR, ionic release mode of operation, positive and negative ions are created such that negative ions attach to the pollutant and drop it out of the air (FIG. 15).

Naturally, in both modes of operation, some ozone and some positive and negative ions are produced. The current apparatus of the present invention, however, is selectable between the two modes of operation for enhancing functional operation of the two modes.

It is evident that the front and rear housing members 26,28 could be formed from injection molded plastic or other well known component materials suggested by those skilled in the art. The housing members 26,28 when connected together, as illustrated, form an efficient and attractively designed housing. The collector plate can be removed easily any time without unplugging the unit from the wall and quickly cleaned with a cloth or other means. Preferably the electrode is formed from a stainless steel or similar conductive, metal material. Although specifications can vary, certain operating specifications have been found advantageous as follows:

TABLE I
Example Specifications for Air Purifier

| | |
|---|---|
| Flow Rate: | 50-100 ft/sec (15-30 m) |
| Ion Output: | 125 trillion/sec |
| O₃ Output: | >0.035 pm |
| Voltage In: | 110,230 v ac |
| Voltage Out: | 6,500 v dc |
| Current Out: | 20 uA |
| Coverage Area: | 12 ft × 12 ft (3.66 × 3.66 m) |
| Unit Weight: | 0.675 lbs (0.3062 kg) |
| Unit Dimensions: | 6.5 × 2.6 × 2.1″ (16.5 × 6.5 × 5.4 cm) |
| Package Dimensions: | 8.1 × 4.9 × 2.7″ (20.6 × 12.4 × 6.9 cm) |

Naturally, these are only non-limiting examples of various operating parameters for an illustrated embodiment of the present invention, but can vary depending on the design and configuration chosen by those skilled in the art.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. An apparatus for purifying and deodorizing air comprising:
a housing;
an electrode positioned within the housing, said electrode having a plurality of emitter members extending from said electrode;
a collector plate mounted within said housing and having a plurality of holes positioned adjacent a respective emitter member;
a voltage generating source mounted within said housing for applying a voltage between the electrode and collector plate; and
wherein said electrode and emitter members are moveable relative to the holes within the collector plate for selecting between a) an oxidating mode of operation that enhances ozone production to allow an oxygen to split off therefrom for oxidizing and neutralizing pollutants, and b) an ionic release mode of operation for enhancing the generation of positive and negative ions such that negative ions attach to pollutants that drop out of the air.

2. An apparatus according to claim 1, wherein said collector plate is slidably mounted within said housing and removable therefrom to facilitate cleaning of the collector plate.

3. An apparatus according to claim 1, wherein said electrode is pivotally mounted within said housing for pivoting said emitter members relative to the holes within the collector plate, such that said emitter members extend adjacent respective holes in the oxidating mode of operation and extend prone relative to said holes when in the ionic release mode of operation.

4. An apparatus according to claim 3, wherein said emitter members comprise triangular configured members terminating in an emitter point that is positioned substantially central to a respective hole when in an oxidating mode of operation.

5. An apparatus according to claim 1, wherein said voltage generating source is operative for power from a standard household current.

6. An apparatus according to claim 1, wherein said voltage generating source is operative for generating a sawtooth waveform.

7. An apparatus according to claim 1, wherein said voltage generating source comprises a transformer, transistor and diode circuit.

8. An apparatus according to claim 1, and further comprising a user operable switch carried by said housing and operably connected to said electrode for manually switching the electrode and emitter members between the oxidating and ionic release modes of operation.

9. An apparatus according to claim 1, wherein said housing comprises a front housing member and rear housing member secured to each other, wherein the electrode is carried by said rear housing member, and said collector plate is carried by said front housing member.

10. An apparatus according to claim 9, wherein said voltage generating source is carried by said rear housing member.

11. An apparatus according to claim 1, and further comprising a night light carried by said housing, connected to said high voltage generating source and operable therefrom.

12. An apparatus for purifying and deodorizing air comprising:
a housing;
a longitudinally extending electrode pivotally mounted within the housing, said electrode having a plurality of linear aligned emitter members extending outward from the electrode and each terminating in an emitter point;
a collector plate slidably mounted within said housing and having a plurality of linear aligned holes such that when the collector plate is mounted within the housing, a hole is positioned adjacent a respective emitter member,
a high voltage generating source mounted within said housing for applying a high voltage between the electrode and collector plate; and
wherein said electrode is pivotably moveable for extending the emitter members in an extended position relative to the collector plate such that an emitter point is positioned substantially central to a respective hole within the collector plate for an oxidating mode of operation that enhances ozone production to allow an oxygen to split off therefrom for oxidizing and neutralizing pollutants, and positioned in a prone position relative to the collector plate for an ionic release mode of operation for enhancing the generation of positive and negative ions such that negative ions attach to pollutants that drop out of the air.

13. An apparatus according to claim 12, wherein said emitter members comprise triangular configured members terminating in an emitter point that is positioned substantially central to a respective hole when in an oxidating mode of operation.

14. An apparatus according to claim 12, wherein said high voltage generating source is operative for power from a standard household current.

15. An apparatus according to claim 12, wherein said high voltage source is operative for generating a sawtooth waveform.

16. An apparatus according to claim 12, wherein said high voltage source comprises a transformer, transistor and diode circuit.

17. An apparatus according to claim 12, and further comprising a user operable switch operably connected to said electrode for pivoting said electrode and manually switching between the oxidating and ionic release modes of operation.

18. An apparatus according to claim 12, wherein said housing comprises a front housing member and rear housing member secured to each other, wherein the electrode is carried by said rear housing member, and said collector plate is carried by said front housing member.

19. An apparatus according to claim 18, wherein said high voltage generating source is carried by said rear housing member.

20. An apparatus according to claim 12, and further comprising a night light carried by said housing, and connected to said high voltage generating source and operable therefrom.

21. An apparatus according to claim 12, wherein said high voltage generating source is operable for generating up to about 7,500 volts.
